(19) United States
(12) Patent Application Publication
(10) Pub. No.: US 2002/0010529 A1
(43) Pub. Date: Jan. 24, 2002

(54) Transportation aid

(76) Inventor: Angela Molden, Laguna Niguel, CA (US)

Correspondence Address: FISH & ASSOCIATES, LLP, 1440 N. HARBOR BLVD., SUITE 706, FULLERTON, CA, 92835, US

(21) Appl. No.: 09/872,172

(22) Filed: May 31, 2001

Related U.S. Application Data
(63) Continuation-in-part of application No. 09/262,135, filed on Mar. 3, 1999, now abandoned.

(51) Int. Cl. G06F 7/00

(52) U.S. Cl. 701/1

(57) ABSTRACT

An improved transportation aid is presented for supporting a person off of the ground while allowing the person to propel himself from one location to another. The transportation aid comprises a body support assembly that supports the torso of an immobilized patient, and at least one wheel assembly having a shield that protects the wheel from accidental contact. The wheel assembly preferably carries the body support assembly between 4″ inches and 32″ inches above a ground level.

### This application is a continuation-in-part of application Ser. No. 09/262135, which was filed on Mar. 03, 1999 with the Title “Improved Transportation Aid”.

### FIELD OF THE INVENTION

The field of the invention is transportation of persons having movement disabilities.

### BACKGROUND OF THE INVENTION

Many people experience temporary or permanent disabilities rendering them unable to move or even to sit without assistance. A variety of transportation aides such as sleds, wheel chairs and mobile beds have been designed over the centuries to help people overcome or alleviate such immobility. Many transportation aides employ wheels of one sort or another, and examples of transportation aides using wheels can be found in U.S. Pat. Nos. 4,512,588, 5,395,129, and 4,082,348 for wheel chairs, and U.S. Pat. Nos. 5,048,133, 4,631,761, 5,153,958 and 4,839,933 for mobile beds.

Many transportation aid designs, such as wheel chair described in U.S. Pat. No. 4,512,588 are geared towards functionality of the wheels. Although such designs may perform well in their designated function, many of them allow people or objects to contact rotating parts of one or more of the wheels, and thereby pose a potential safety hazard. For example, material such as clothing or medical supplies accidentally left on the ground can be caught up in a wheel, possibly destroying the material or immobilizing the wheel. Moreover, accidental contact of a person with an unprotected rotating part in a wheel may result in serious injury to the person. In many known designs, serious injury to a person's fingers is particularly likely.

Therefore, there is still a need for transportation aides having improved safety.

### BRIEF DESCRIPTION OF THE DRAWING

FIG. 1 is a side view of a transportation aid embodying the claimed invention.

FIG. 2 is a top view of the transportation aid of FIG. 1.

FIG. 3A is first perspective view of another exemplary transportation aid.

FIG. 3B is second perspective view of the transportation aid of FIG. 3A.

### SUMMARY OF THE INVENTION

In accordance with the present invention, an improved transportation aid supports a person off of the ground, while allowing the person to propel himself from one location to another. Safety is improved over previous transportation aides by at least partially shielding the wheel assembly.

In preferred embodiments the shielding is provided by an inverted cup-shaped apparatus having a lower portion that extends circumferentially around the wheel, and below the height of the wheel's axle.

Various objects, features, aspects and advantages of the present invention will become more apparent from the following detailed description of preferred embodiments of the invention, along with the accompanying drawings in which like numerals represent like components.

### DETAILED DESCRIPTION OF SPECIFIC EMBODIMENTS

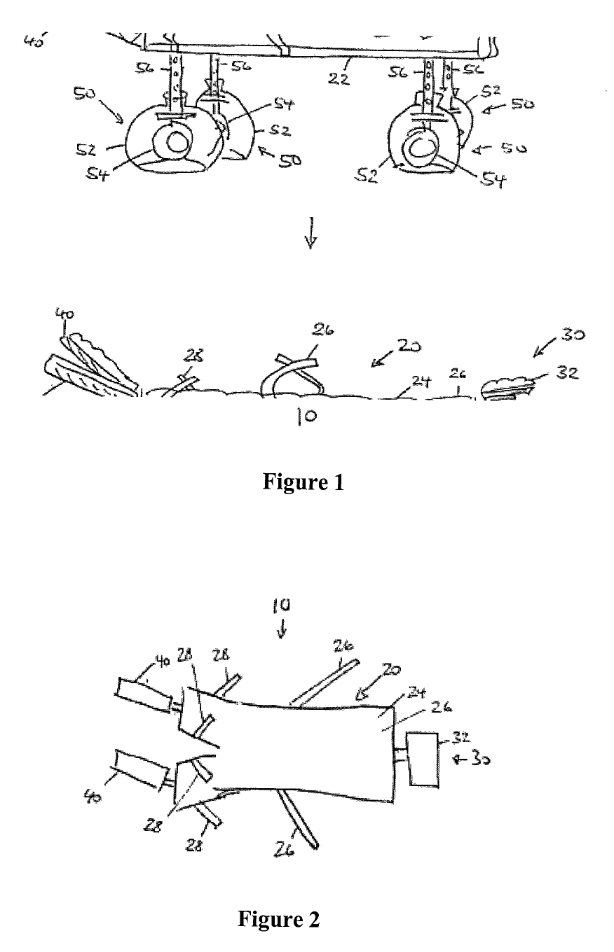

Referring to FIG. 1, a transportation aid 10 generally comprises four wheel assemblies 50 couplet to a to a body support assembly 60 using a leg 56. Each wheel assembly 50 generally comprises a shield 52 and a wheel 54. Body support assembly 60 generally comprises headrest 30, and leg rests 40 coupled to bed rest 20. Each of the leg rests 40 includes body straps 26. Bed rest 20 includes thigh straps 28.

The term “transportation aid” is used herein in a very broad sense to mean any device that is adapted to provide mobility to a person, while supporting substantially the entire weight of the person. Among other things, this definition includes cots and other gurneys, mobile beds, and wheel chairs.

The shield 52 of wheel assembly 50 may have any reasonable combination of size, shape or material so long as it substantially blocks access to the wheel 54, but still allows the wheel 54 to contact the ground. The phrase “substantially blocks access to the wheel” is a shorthand way of saying that a person's fingers, body parts or other objects are substantially hindered from accidentally contacting the wheel.

Blocking access to a wheel can be accomplished in a number of ways, including forming the shield as a continuous surface that acts as an immediate physical barrier. Another example of blocking access to a wheel is a shield with a discontinuous surface, with openings of a size limited to the size of less than the diameter of a finger. In still another alternative embodiment, the shield can be placed at a distance from the wheel that is greater than the length of a finger. Therefore, any object that is not located within the shield must travel around the shield and the lower edge of the shield in order to contact the wheel.

In a preferred embodiment, shield 52 is spherical, about 9 inches in diameter, and has its lower portion less than half an inch above the ground. Shield 52 can be constructed from any suitable material, preferably a non-perforated PVC (polyvinylchloride) material, or equivalent. Preferred shield 52 is advantageously coupled by a Velcro™ fastener to the leg 56.

In alternative embodiments, the shield may have a different physical configuration from that shown in FIG. 1, for example, cylindrical, box-shaped or bell-shaped. In other embodiments the surface of shield may be continuous or discontinuous. For example, a discontinuous surface may be formed from a mesh, or otherwise incorporate perforations in a shield that, because of size or some other factor, still hinders access to the wheel. In contrast, a continuous surface is a non-perforated surface, which may be smooth, shaped in waves, have indentations or extensions.

The shield may be made from various materials other than, or in addition to, PVC, including natural and synthetic polymers, metals or other man-made materials or any combination thereof. For example shield may be made from rubber, acrylic, aluminum, fiberglass or graphite. The shield may advantageously include a surface coating. Such coatings may be used for esthetic or functional purposes. Examples of esthetic coatings are paint or prints. Functional coatings may include materials that resist chemical disinfectants, or may make the shield especially resistant towards mechanical stress or impact.

While shield 52 is preferably coupled to leg 56 using a Velcro™ fastener, the manner of coupling may vary among embodiments. Thus, some embodiments may utilize screws as fasteners, or may utilize, tightening rings, belts or any other suitable couplers.

Wheel 54 of wheel assembly 50 may be any sort of wheel so long as it is capable of supporting its share of the load provided by body support assembly 60. In preferred embodiments, wheel 54 comprises a simple solid disk or spherical elements rotatably coupled to an axle. In other embodiments, wheel 54 may have one or more complex wheels rotatably coupled to an axle, wherein the wheels comprise rim, spokes, tubes or tires.

Similarly, although wheel 54 is preferably constructed of an aluminum disk with a rubber tire, alternative wheels may be made from any suitable material or materials, including metals, natural or synthetic polymers, other man-made material or mixtures thereof.

Wheel 54 is preferably about two inches in diameter. However, alternative wheels may have any appropriate size as long as it can mechanically cooperate with shield 52.

Leg 56 may take any form so long as it allows wheel 54 to be coupled to body support assembly 60. Generally, leg 56 is contemplated a structure, which connects wheel assembly 50 to body support assembly 60. More than one wheel may be coupled to leg 56. In a preferred embodiment, leg 56 is a long hollow aluminum cylinder (1″ diameter, 15″ length) and is coupled to the body support assembly, the shield and one wheel.

In alternative embodiments, the leg(s) may have various shapes including bars, double T-bars, columns or rods that may or may not be hollow or perforated. In other alternative embodiments, the leg may be made from other materials than shown in the preferred embodiment including natural or synthetic polymers, metal or other man-made materials. Examples for such materials are wood, PVC, stainless steel or fiberglass.

In further embodiments, the leg(s) may have additional functional support elements including shock absorbers, additional stabilizers or height adjusters. Examples for shock absorbers are, among others, simple rubber cushions, spring mechanisms or gas filled shocks. Examples for additional stabilizers include cross bars connecting leg 56 to the body support assembly, or crossbars connecting leg 56 to another leg. Height adjusters are, for example, screws holding the body support assembly in a fixed distance relative to wheel 54, or hydraulic, pneumatic or electric mechanisms that can hold body support assembly 60 in a variable distance from wheel 54.

Bed rest 20 of body support assembly 60 preferably comprises a base support portion 22, and a mattress portion 24 having an upper supporting surface 26. Bed rest 20 may be variably positioned within the range of 4″ to 32″ from the ground with respect to the upper supporting surface 26. The term “variably positioned” refers to any kind of manipulation on body support assembly 60, wheel assembly 50 or leg 56 that changes the vertical distance between the upper supporting surface 26 and the point where wheel 54 contacts the ground. The change in vertical distance may be incremental or continuous. The upper supporting surface of mattress 26 as used herein refers to the topmost portion of mattress 24.

Base support 22 preferably comprises an aluminum platform. However, in alternative embodiments it may also be made from various other materials including metals, wood, natural and synthetic polymers, man-made materials and combinations thereof. Examples for other materials are stainless steel, polystyrene, or fiberglass.

In an alternative embodiment, a base support may be constructed in various shapes or forms including a plate that may or may not be perforated, bed frame-like structures or spring boxes. Other shapes or forms include additional elements to enhance functionality or comfort. For example, hinge mechanisms in base support 22 allowing portions of base support 22 to be raised or lowered. Further examples include electrical, pneumatic or hydraulic devices that can operate the support. Still further examples include forms that are molded to individualy fit a person's body.

Mattress 24 preferably has a foam filling and a vinyl cover and mattress 24 has an upper supporting surface 26. The term upper supporting surface refers to the topmost portion of mattress 24.

In alternative embodiments, mattress 24 may be made in many ways including various filling and cover portions. The filling portion may be made of compressible materials including air, polymers, latex, springs, fabrics, or any combination thereof or may be made of incompressible elements such as hard plastic, wood, water or other fluids. In other embodiments, the filling portion may have additional elements, including heating or cooling elements to achieve a constant or adjustable temperature. The cover portion of mattress 24 can be made of materials other than vinyl, including natural or synthetic polymers, textiles, and woven fabrics.

In yet another embodiment, the surface of mattress 24 may be designed to provide comfort to a person or can be geared towards hygienic requirements. For example surfaces enhancing comfort include woven fabrics, wool or other textiles. Examples for hygienic surfaces are disinfectable or waterproof materials including PVC or polyester.

Headrest 30 has a head receiving portion 32 and is preferably a vinyl covered foam pillow coupled to the bed rest by a pair of cylinders. In alternative embodiments, the headrest may have shapes other than a pillow. Examples therefore are U-shaped headrests that stabilize a particular position of a head or a ring-shaped headrest.

In further alternative embodiments, headrest comprises a cover portion and a cushion portion. The cover portion can be made from a variety of materials including fabrics, leather, natural or synthetic polymers. The cushion portion can be made from latex or Styrofoam.

In yet another alternative embodiment, headrest 30 can have various means of attachment to bed rest 20. For example, the headrest can be an integral part of bed rest 20, or detachable using guide rails, rods, screws or lock-type mechanical connectors. In other alternative embodiments, the headrest can be mounted underneath bed rest 20 and hidden away when not in use.

In a preferred embodiment, leg rests 40 have a U-shaped profile, are made from hard plastic and are detachably coupled to bed rest 20. In alternative embodiments, the leg rests may be made from any other material and may have various other forms. For example, appropriate leg rests may be made from wood or metal and may be flat. In further alternative embodiments, the leg rests may be pivotably coupled to the bed rest.

Preferred body straps 26 and preferred thigh straps 28 are nylon straps with Velcro™ fasteners. In an alternative embodiment, the body- and thigh straps can be made from alternative material or have an alternative form or shape. Alternative materials include, but are not limited to natural and synthetic polymers, fabrics, leather or textile material, but also metal. Form or shape of the body straps 26 and the thigh straps 28 include different forms of attachment to the bed rest, various forms of closing mechanisms and optional additional elements. Examples for different forms of attachment include push-buttons, Velcro™ fasteners, glue, tacks etc. Examples for different closing mechanisms include buckles, Velcro™ fasteners, hooks or a simple knot. Additional elements can be cushions, locks or pockets for nametags.

In still further preferred aspects of the inventive subject matter, the body support assembly of contemplated the transportation aids is configured to support a torso of an immobilized patient without supporting at least one of an arm and a leg of the patient. The term “torso” as used herein generally refers to the body of a human substantially excluding (i.e., excluding at least 70% with respect to their longest dimension) the head, neck, arms and legs. As further used herein, the term “immobilized patient” refers to a person that cannot move from a first location to a second location without assistance of another person or device (e.g., cast, walker, wheel chair, etc.). For example, a child in a body cast is considered an immobilized patient under the scope of this definition. Thus, this definition particularly excludes a healthy individual (e.g., an auto mechanic).

Contemplated transportation aids further comprise a wheel assembly having a wheel supported at an axle such that at least a lower portion of a shield extends below the axle, and still further comprise a leg that couples the wheel assembly to the body support assembly, wherein the leg has a length that allows the patient to propel himself from one location to another using the at least one of an arm and a leg while the body support assembly supports the patient.

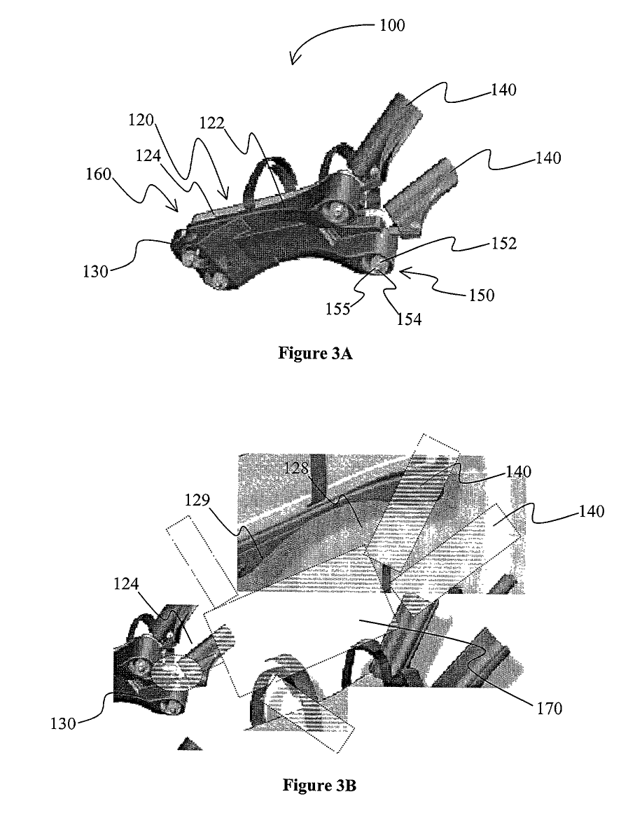

An exemplary further preferred transportation aid is depicted in FIGS. 3A and 3B. Here, the transportation aid 100 generally comprises four wheel assemblies 150 coupled to a to a body support assembly 160 using a leg 156 (not shown). The body support assembly 160 comprises a base support portion 122 and a mattress 124. Each wheel assembly 150 generally comprises a shield 152 and a wheel 154 coupled to an axle 155. Body support assembly 160 further comprises a detachable headrest 130, and detachable leg rests 140. Bed rest 120 includes thigh straps 128, and the mattress includes a body strap 129. The immobilized patient 170 lies with its torso supported by the body support assembly 160 on its stomach (or alternatively back or side), and propels him or herself using one or both hands or feet, or both.

Thus, specific embodiments and applications of transportation aides with safety wheels have been disclosed. It should be apparent, however, to those skilled in the art that many more modifications besides those already described are possible without departing from the inventive concepts herein. For example, the transportation aid may be designed to preferably support a person in a way other than lying on the stomach or a motor drive the transportation aid. The inventive subject matter, therefore, is not to be restricted except in the spirit of the appended claims.

What is claimed is:

1. A transportation aid comprising:
a body support assembly configured to support a torso of an immobilized patient without supporting at least one of an arm and a leg of the patient;
a wheel assembly having a wheel supported at an axle such that at least a lower portion of a shield extends below the axle; and
a leg that couples the wheel assembly to the body support assembly, wherein the leg has a length that allows the patient to propel himself from one location to another using the at least one of an arm and a leg while the body support assembly supports the patient.

2. The transportation aid of claim 1 wherein the body support assembly further comprises a detachable leg support.

3. The transportation aid of claim 1 wherein the shield is movably coupled to the wheel assembly so that the lower portion is raised and lowered relative to the axle.

4. The transportation aid of claim 1 wherein the wheel assembly carries the body support assembly at a fixed distance H inches above a ground level, where H is between 4″ inches and 32″ inches, inclusive.

5. The transportation aid of claim 1 wherein the wheel assembly carries the body support assembly at a variable H inches above a ground level, where H is between 4″ inches and 32″ inches, inclusive.

6. The transportation aid of claim 5 wherein the body support assembly has a bed rest and at least one leg rest, the leg rest coupled to the bed rest and the bed rest adjustably coupled to the wheel assembly.

7. The transportation aid of claim 6 wherein the at least one leg rest is removable from the body support.

8. The transportation aid of claim 5 wherein the body support assembly has a bed rest and a headrest, the headrest being adjustably coupled to the bed rest.

9. The transportation aid of claim 5 wherein the body support assembly has a bed rest, the bed rest having a head receiving portion that can be adjusted upwardly and downwardly.

10. The transportation aid of claim 5 wherein the body support assembly further comprises a leg rest having an end pivotably coupled to the body support assembly.
